(19) United States
(12) Patent Application Publication
(10) Pub. No.: US 2013/0203312 A1
(43) Pub. Date: Aug. 8, 2013

(54) Apparatus for Insulating Against Radiant Energy

(71) Applicants: Richard D. Jordan, Lawrenceville, GA (US); Michael E. Carroll, Loganville, GA (US)

(72) Inventors: Richard D. Jordan, Lawrenceville, GA (US); Michael E. Carroll, Loganville, GA (US)

(21) Appl. No.: 13/510,045

(22) PCT Filed: Nov. 16, 2010
(86) PCT No.: PCT/US10/56769

§ 371 Date: May 24, 2012

Related U.S. Application Data
(60) Provisional application No. 61/261,874, filed on Nov. 17, 2009.

(51) Int. Cl. E04B 1/76; B32B 27/08; B32B 5/02; B32B 15/085; B32B 15/09; B32B 5/00

(52) U.S. Cl. CPC E04B 1/762; B32B 15/09; B32B 5/00; B32B 5/028; B32B 15/085; B32B 27/08
USPC 442/2; 428/458; 428/457; 428/480; 428/335; 428/461; 428/483

(57) ABSTRACT

Disclosed is a radiant barrier including a first reflective layer, a second reflective layer and a support interposed therebetween. The reflective layers and the support essentially do not define a pocket. The support has sufficient rigidity such that, when bowed, said support develops an outward force that is sufficient to maintain the radiant barrier in an installed position, for example between roofing rafters.

### BACKGROUND OF THE INVENTION

The present invention relates generally to do-it-yourself (DIY) radiant barrier applications for preexisting home and aftermarket installations.

Roofs and siding, which form the outer covering of a building or house, are subject to high temperatures in the summer that increase heat inside the house and significantly increase the costs of cooling the interior space. In many cases, a layer of insulation is provided on the floor of the attic. However, such insulation tends to be expensive, bulky, limited to the available attic or wall space, and often is ineffective in preventing radiant saturation of the insulation from occurring as a result of the high temperatures that build up in the attic roof and wall surfaces. Moreover, such insulation is completely ineffective for lowering the attic temperatures, and may even cause the attic temperatures to increase by trapping the heat therein. Higher attic temperatures dramatically increase the likelihood of heat radiating into the house, while existing roof constructions tend to increase the temperature of houses in the summer, in the winter, the roofs are a significant source of heat loss as in cold environments the radiant transfer for saturation only requires a temperature difference between the attic surfaces and the living space.

Roofing construction for homes or buildings generally consists of decking, which may include sheets of plywood, oriented strand board (OSB), and the like, which are nailed or otherwise fastened to structural members such as rafters and beams that define the roof of the structure. The decking forms a substrate onto which water-shedding materials, such as tar paper, also called felt, shingles, slate and metal, may be added to complete the roof.

The above-described roofing structure alone provides inadequate insulation. Insulative materials have been provided to the exterior and interior sides of the decking, such as polystyrene boards with insulating materials mounted thereon. However, installation of such materials increases construction cost, and the necessary materials tend to be expensive and bulky to handle.

Oriented strand board decking has been insulated in a variety of ways. For example, heat reflective layers have been provided with oriented strand board decking. However, this type of material tends to be expensive to manufacture. Additionally, replacing roofs with oriented strand board having heat integral reflective materials first requires demolition and replacement of the entire non-insulated decking to obtain the benefits of insulated decking, which greatly increases the cost of roof replacement.

It would be an improvement to the prior art to provide an inexpensive, toollessly-installed radiant barrier that may be utilized by DIY home installations or on new roof and reconstruction to help reduce the current energy generation contribution to CO₂ emissions by reducing home and building cooling and heating energy demands.

### SUMMARY OF THE INVENTION

The DIY heat reflective radiant barrier system:
a. is easily handled and can be installed by anyone regardless of construction knowledge or proficiency;
b. may be supplied in rolls or simple sheets in a compact form for ease of storage, transport and deployment;
c. may be applied in rolls or simple sheets that are placed across or between rafters, studs and other roof structures;
d. is installed without any former knowledge or requirement of specialized labor or tools; and
e. is installable without replacing rigid panels that form the roof or walls.

To that end, an embodiment of a radiant barrier configured according to principles of the invention includes a reflective layer and a support mounted thereon, wherein the support has sufficient rigidity such that, when bowed, the support develops an outward force that is sufficient to maintain the radiant barrier in an installed position, for example between roofing rafters.

These and other features, and advantages of the present invention will become apparent from the drawings and the descriptions given herein. However, it will be understood that the above-listed features of the invention are intended only as an aid in understanding aspects of the invention, and are not intended to limit the invention in any way, and therefore do not form a comprehensive or restrictive list of features and/or advantages of the invention.

The invention provides improved elements and arrangements thereof, for the purposes described, which are inexpensive, dependable and effective in accomplishing intended purposes of the invention.

Other features and advantages of the invention will become apparent from the following description of the preferred embodiments.

### BRIEF DESCRIPTION OF THE DRAWINGS

The invention is described in detail below with reference to the following figures, throughout which similar reference characters denote corresponding features consistently, wherein:

FIG. 1 is a perspective view of an embodiment of a radiant barrier configured according to principles of the invention, the reflective layers thereof shown partially peeled back from a structural support; and

FIG. 2 is an environmental perspective view of the embodiment of FIG. 1 installed between joists.

### DETAILED DESCRIPTION OF THE PREFERRED EMBODIMENTS

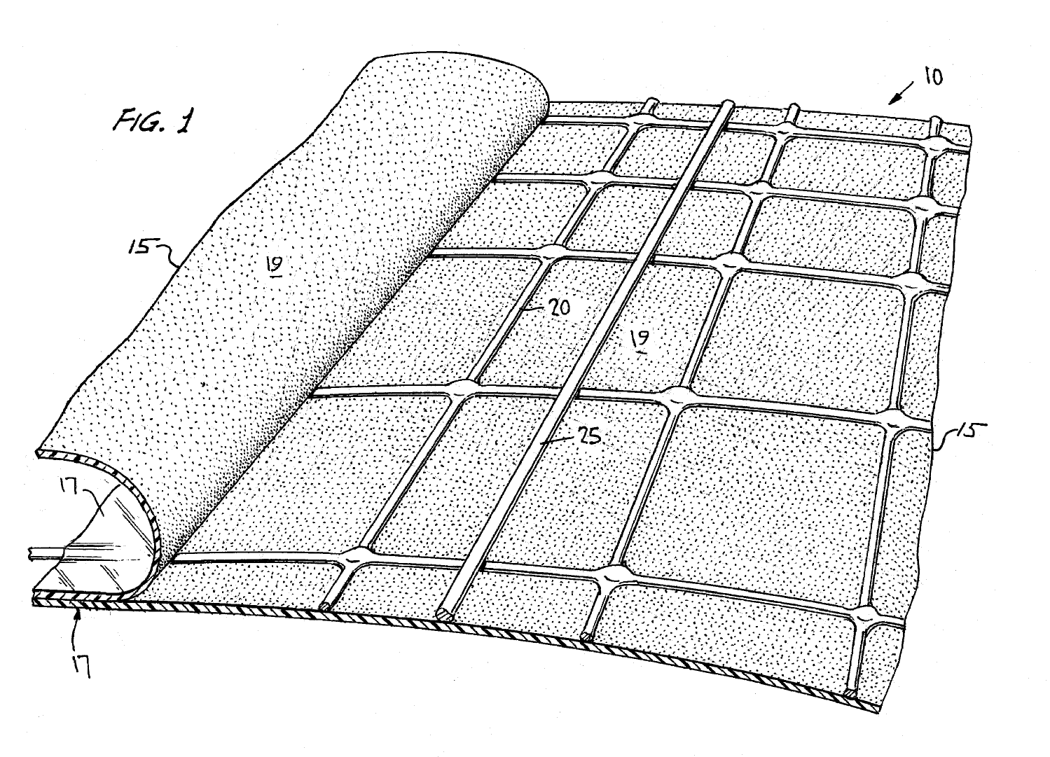

The invention is a heat reflective radiant barrier system that is installable without tools into existing or new roof systems of a building or home. Referring to FIG. 1, one embodiment of the present heat reflective radiant barrier 10 includes a reflective layer 15 mounted on a support structure 20.

The reflective layer 15 has an outer surface 17 and an inner surface 19. Outer surface 17 has low emissivity and/or is heat reflective. Inner surface 15 is preferred for mounting on the support structure 20.

The reflective layer may be constructed of many sublayers, preferably selected from a film, a foil, a metalized film or metalized foil having a gage ranging from 48 to 92. Preferably, the film is constructed of polyester, which, during appropriate testing, melts without burning.

The preferred emissivity of outer surface 17 of reflective layer 15 is 0.04 or has 96% reflectivity.

Support structure 20 is constructed of at least one layer of flexible, semi-rigid material, preferably constructed of polypropylene, which, during appropriate testing, melts without burning.

Preferably, each of reflective layers 15 is mounted on either side of support structure 20 with a bonding agent, preferably one that is pressure sensitive. One embodiment has the bonding agent is disposed on one or both inner surfaces 19 of reflective layers 15. When assembled, one or both inner surfaces 19 adhere to a respective side of support structure 20 as well as to each other.

Another embodiment (not shown) has the bonding agent on support structure 20. When assembled, both inner surfaces 19 adhere to a respective side of support structure 20, but not to each other. This embodiment provides air pockets defined within the latticework of support structure 20 and between reflective layers 15 mounted on either side.

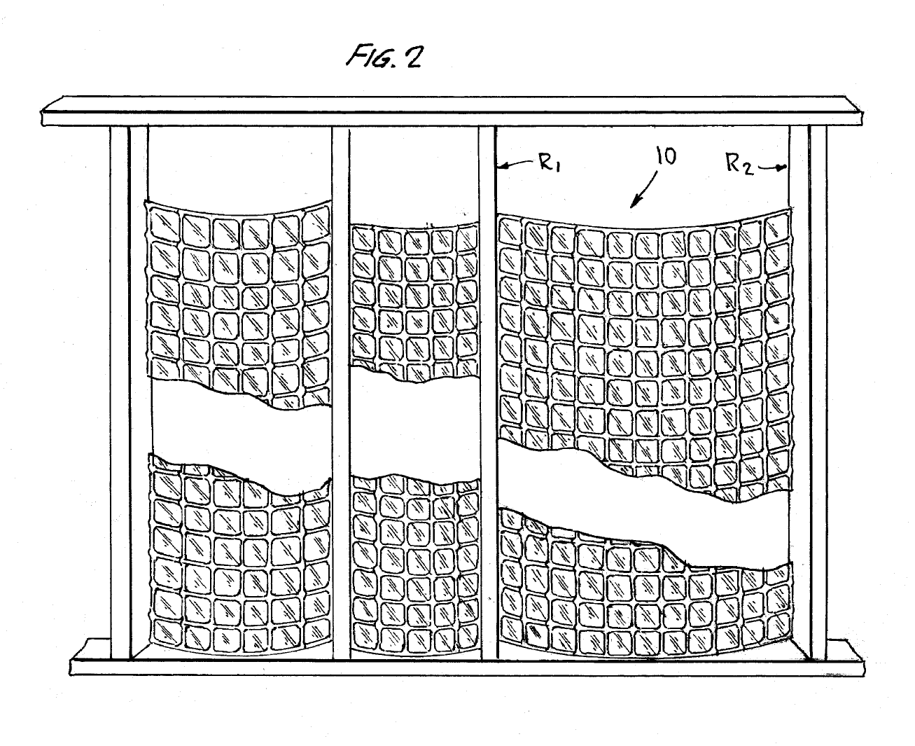

Referring to FIG. 2, in practice, radiant barrier 10 is secured between roof structures or joists without the need for tools. Preferably, radiant barrier 10 is self-securing in that it may be bowed and, due to the rigidity of support structure 20, develop an outward spring force sufficient to maintain radiant barrier 10 in an installed configuration, for example between generally opposed surfaces of support structures R1, R2, such as rafters of a roof structure, thereby effectuating an interference fit. The interference fit should be sufficient to withstand at least the weight of radiant barrier 10.

Referring to FIG. 1, an alternative embodiment provides metal rods or lateral stiffeners 25 that may be disbursed like rungs of a ladder along the length of the invention to add support or stiffness to the invention when installation between joists, comparable to the insulation supports used with conventional attic insulation. While the invention is intended to be self-securing or self-supporting, real-world installations may not provide optimal spacing between joists, rafters or other support structures, and instead may have a greater spacing than that which would foster the spring force mentioned above. Other non-ideal installations may provide variable spacing between support structures, for example where the support members are bowed or installed such that the spacing therebetween varies in an amount that would not foster the necessary spring forces along radiant barrier 10 to maintain it between the support members. Where the spring forces developed in radiant barrier 10 are inadequate to maintain it in an installed position, stiffeners 25 would be installed to lend additional support to maintain radiant barrier 10 in an installed position.

The composition of the present heat reflective radiant barrier 10 may vary, and may be constructed of one or more materials from the group consisting of reflective foil or films, semi-rigid polymers, metal and/or mechanical stiffeners, along with composition bonding agents.

A method of making the present heat reflective radiant barrier 10 for use in a building or house involves providing low emissivity/heat reflective layer(s); providing one or more semi-rigid material layer(s), with or without additional stiffeners, substantially similar in size to the low emissivity layer; combining or bonding the low emissivity/heat reflective layer(s); with the semi-rigid material layer(s), whereby the low emissivity/heat reflective layer(s); and the semi-rigid material layer(s) assume a configuration that may be installed without the need for tools or via a fastening method preferred by the user simultaneously between the roof structures of a building or house.

The invention is not limited to the particular embodiments described and depicted herein, rather only to the following claims.

1. Apparatus for insulating against radiant energy comprising:
a first reflective layer;
a second reflective layer; and
a support interposed between said first reflective layer and said second reflective layer;
wherein:
said first reflective layer, said second reflective layer and said support essentially do not define a pocket; and
said support has sufficient rigidity such that, when bowed, said support develops a spring force that is sufficient to maintain said apparatus in an installed position.

2. Apparatus of claim 1, wherein one or both of said first reflective layer and said second reflective layer are constructed of one or more of: a film, a foil, a metalized film, a metalized foil and combinations thereof.

3. Apparatus of claim 2, wherein said foil and/or said metalized foil have a gage ranging from 48 to 92.

4. Apparatus of claim 2, wherein said film and/or said metalized film is constructed of polyester.

5. Apparatus Apparatus of claim 1, wherein one or both of said first reflective layer and said second reflective layer have an inner surface that contacts said support, and an outside surface that has an emissivity of 0.04.

6. Apparatus of claim 1, wherein said support defines a lattice.

7. Apparatus of claim 1, wherein said support is constructed of at least one layer of polypropylene.

8. Apparatus of claim 1, further comprising a pressure sensitive bonding agent interposed between said first reflective layer and said second reflective layer; said first reflective layer and said support; said second reflective layer and said support; or combinations thereof.

9. Apparatus of claim 1, further comprising a stiffener that contacts or is mounted on said first reflective layer, said second reflective layer, said support, or combinations thereof;
wherein said stiffener has sufficient rigidity such that, when bowed, said stiffener develops a spring force that is sufficient to maintain said apparatus in an installed position.

10. Apparatus of claim 1, further comprising insulation interposed between said first reflective layer and said second reflective layer; said first reflective layer and said support; said second reflective layer and said support; or combinations thereof.

11. (canceled)

12. (canceled)
